(19) United States
(12) Patent Application Publication
(10) Pub. No.: US 2026/0126737 A1
(43) Pub. Date: May 7, 2026

(54) OPTICAL SCANNING DEVICE, IMAGE FORMING APPARATUS INCLUDING OPTICAL SCANNING DEVICE, AND METHOD OF MANUFACTURING OPTICAL SCANNING DEVICE

(71) Applicant: SHARP KABUSHIKI KAISHA, Osaka (JP)

(72) Inventors: Hidenori SATO, Osaka (JP); Akito TERAMOTO, Osaka (JP); Yusuke TAKI, Osaka (JP); HIROSHI YAMAMOTO, Osaka (JP)

(21) Appl. No.: 19/371,210

(22) Filed: Oct. 28, 2025

(30) Foreign Application Priority Data
Nov. 1, 2024 (JP) 2024-192940

(51) Int. Cl. G03G 15/041; B41J 2/44; B41J 2/47; G02B 26/12; G03G 15/04

(52) U.S. Cl. CPC G03G 15/0415; B41J 2/44; B41J 2/471; G03G 15/04036; G02B 26/12

(57) ABSTRACT

An optical scanning device comprises a component fixer including a one-end fixer that fixes one end of an optical component and an other-end fixer that fixes an other end of the optical component, wherein the one-end fixer includes a one-end positioner that positions an other surface of the one end and at least one one-end side protruding portion that supports the other surface in an inclined state with respect to a horizontal plane, the other-end fixer includes an other-end positioner that positions the other surface of the other end and at least two other-end side protruding portions that support the other surface in an inclined state with respect to the horizontal plane, and an other-end adhesive fixer fixes the other end to the other-end positioner and includes portions at which the other surface is fixed to the at least two other-end side protruding portions.

### CROSS-REFERENCE TO RELATED APPLICATION

The present application claims priority from Japanese Application JP2024-192940, the content of which is hereby incorporated by reference into this application.

### BACKGROUND

### 1. Field

The disclosure relates to an optical scanning device, an image forming apparatus including the optical scanning device, and a method of manufacturing the optical scanning device.

### 2. Description of the Related Art

In the related art, an optical scanning device provided at an image forming apparatus irradiates a photoreceptor, which is an irradiation target, with light from a light source (hereinafter, may be referred to as scanning light) to form a latent image on a surface of the photoreceptor. A multi-color image forming apparatus (hereinafter, may be referred to as a color image forming apparatus) includes a plurality of drum-shaped photoreceptors corresponding to a plurality of colors (for example, four colors of black, cyan, magenta, and yellow), and an optical scanning device including a plurality of optical scanning systems individually corresponding to the plurality of photoreceptors. In such a color image forming apparatus, each optical scanning system is provided with a bar-shaped mirror having a rectangular cross section for reflecting the scanning light from the light source toward the photoreceptor. Both ends of a plurality of mirrors of the respective optical scanning systems in the longitudinal direction are fixed to a pair of gripping portions provided in a housing (optical box) of the optical scanning device.

The gripping portions each include a mirror-supporting recessed portion provided at a bottom surface in the housing, and a thin plate spring attached to the housing. The mirror-supporting recessed portion positions the mirror so as to support the mirror at a predetermined inclination angle with respect to a horizontal plane. The thin plate spring is opposed to the mirror, and is in contact with the opposing surfaces of the mirror to bias the mirror toward the mirror-supporting recessed portion.

### SUMMARY

In the case of the optical scanning device in the related art, when both ends of the mirror are fixed to the gripping portions, one end of the mirror is inserted and fixed between the mirror-supporting recessed portion and the thin plate spring in one gripping portion, and the other end of the mirror is similarly fixed to the other gripping portion. At this time, on both end sides of the mirror, a part of the mirror, a part of the thin plate, or a part of the mirror-supporting recessed portion may be scraped due to contact between the mirror and the thin plate spring and contact between the mirror and the mirror-supporting recessed portion, and a failure in the inclination angle of the mirror may occur. The failure in the inclination angle of the mirror may cause an optical axis failure, which leads to an optical axis arrival failure, and may cause a beam diameter failure, which leads to a performance failure.

An object of the disclosure is to provide an optical scanning device and an image forming apparatus including the same, which are made in consideration of the above-described circumstances.

The disclosure provides an optical scanning device including: a light source; an optical component irradiated with light from the light source; a housing that accommodates the optical component; and a component fixer that fixes the optical component in the housing. The optical component has a shape extending in a longitudinal direction intersecting an irradiation direction of the light, and an outer peripheral surface facing a direction orthogonal to the longitudinal direction. The outer peripheral surface of the optical component includes one surface and another surface supported by the component fixer. The component fixer includes a one-end fixer that fixes one end of the optical component in the longitudinal direction, and an other-end fixer that fixes the other end of the optical component in the longitudinal direction. The one-end fixer includes a one-end positioner that positions the other surface of the one end of the optical component and a biaser that biases the one surface to the one-end positioner side. The other-end fixer includes an other-end positioner that positions the other surface of the other end of the optical component, and an other-end adhesive fixer by which the other end is fixed to the other-end positioner. The one-end positioner includes at least one one-end side protruding portion that supports the other surface in an inclined state with respect to a horizontal plane. The other-end positioner includes at least two other-end side protruding portions that support the other surface in an inclined state with respect to the horizontal plane. The other-end adhesive fixer includes portions at which the other surface is fixed to the at least two other-end side protruding portions.

The disclosure provides an image forming apparatus including the optical scanning device, a photoreceptor on which a latent image is formed by being irradiated with the light from the optical scanning device, and a development device that develops the latent image formed on the photoreceptor.

The disclosure provides a method of assembling the optical scanning device, the method including: a step of bringing the other surface of the other end of the optical component into contact with the at least two other-end side protruding portions of the other-end positioner, positioning the other end of the optical component to the other-end positioner in an inclined state with respect to the horizontal plane, bringing the other surface of the one end of the optical component into contact with the at least one one-end side protruding portion of the one-end positioner positioning the one end of the optical component to the one-end positioner in an inclined state with respect to the horizontal plane, and biasing the one surface toward the one-end positioner side by the biaser; and a step of applying an adhesive to contact portions between the at least two other-end side protruding portions and the other surface of the optical component and curing the adhesive to form the other-end adhesive fixer.

According to the disclosure, it is possible to prevent an inclination angle failure of the optical component due to scraping of the component and to suppress deterioration of a device performance due to the inclination angle failure of the optical component.

### BRIEF DESCRIPTION OF THE DRAWINGS

FIG. 1 is a schematic cross-sectional view illustrating an image forming apparatus including an optical scanning device according to a first embodiment of the disclosure, as viewed from a front side.

FIG. 2 is a plan view illustrating the optical scanning device according to the first embodiment.

FIG. 3 is a cross-sectional view taken along line I-I in FIG. 2.

FIG. 4 is a schematic side view illustrating a positional relationship between an emission optical system and photoreceptors of the optical scanning device illustrated in FIG. 3, as viewed from the front side.

FIG. 5 is a cross-sectional view illustrating a state of one end side of an optical component fixed to a component fixer in the optical scanning device of the first embodiment, as viewed from the front side.

FIG. 6 is a cross-sectional view illustrating a state of an other end side of the optical component fixed to the component fixer in the optical scanning device of the first embodiment, as viewed from a rear side.

FIG. 7 is a cross-sectional view illustrating a state of the component fixer before component fixing in the optical scanning device of the first embodiment, as viewed from the front side.

FIG. 8 is a cross-sectional view illustrating a state of the component fixer before component fixing in the optical scanning device of the first embodiment, as viewed from the rear side.

FIG. 9 is a cross-sectional view illustrating a state of fixing the other end of the optical component to the component fixer in the optical scanning device of the first embodiment, as viewed from the rear side.

FIG. 10 is a cross-sectional view illustrating a state of fixing the one end of the optical component to the component fixer in the optical scanning device of the first embodiment, as viewed from the front side.

FIG. 11 is a cross-sectional view illustrating a state where the other end of the optical component is temporarily fixed to the component fixer in the optical scanning device of the first embodiment, as viewed from the rear side.

FIG. 12 is a cross-sectional view illustrating a state where the one end of the optical component is temporarily fixed to the component fixer in the optical scanning device of the first embodiment, as viewed from the front side.

FIG. 13 is a cross-sectional view illustrating a state of one end side of an optical component fixed to a component fixer in an optical scanning device of a second embodiment, as viewed from the front side.

FIG. 14 is a cross-sectional view illustrating a state of an other end side of the optical component fixed to the component fixer in the optical scanning device of the second embodiment, as viewed from the rear side.

### DETAILED DESCRIPTION OF THE DISCLOSURE

Hereinafter, embodiments of the disclosure will be described in further detail by using the drawings. In the following description, the same components are denoted by the same reference signs. The same applies to the names and functions of the components.

Therefore, detailed descriptions thereof are not repeated. Note that the following description is in all aspects illustrative and should not be understood as limiting the disclosure.

### First Embodiment

### Entire Configuration of Image Forming Apparatus

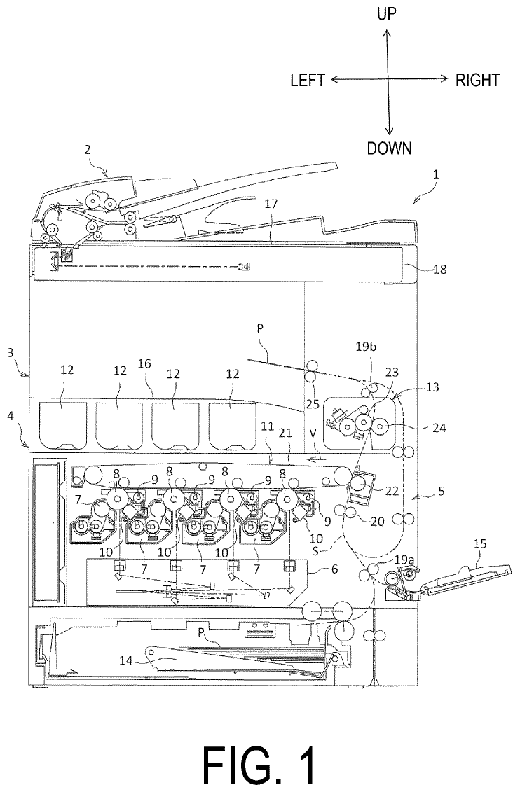

FIG. 1 is a schematic cross-sectional view illustrating an image forming apparatus 1 including an optical scanning device 6 according to a first embodiment of the disclosure, as viewed from a front side. In FIG. 1, the up, down, left, and right directions when the image forming apparatus 1 is viewed from the front side are indicated by arrows. The image forming apparatus 1 according to the first embodiment is a color image forming apparatus. The image forming apparatus 1 forms a multicolor image on a sheet P based on image data read by an image reading device 18, or image data transmitted from the outside. Note that the image forming apparatus 1 may be a color image forming apparatus of another configuration.

The image forming apparatus 1 includes a document feeding device 2 and an image forming apparatus body 3, and the image forming apparatus body 3 includes an image former 4 and a sheet conveyance system 5.

The image former 4 includes an optical scanning device 6, a plurality of development devices 7, a plurality of photoreceptors 8 each having a drum shape and serving as an image carrier, a plurality of cleaning devices 9, a plurality of charging devices 10, an intermediate transfer belt device 11, a plurality of toner storage devices 12, and a fixing device 13. The sheet conveyance system 5 includes a feed tray 14, a manual feed tray 15, and a discharge tray 16.

A document table 17 made of transparent glass on which a document (not illustrated) is placed is provided at an upper portion of the image forming apparatus body 3. The image reading device 18 for reading an image of the document is provided at a lower portion of the document table 17. Further, the document feeding device 2 is provided above the document table 17. The image of the document read by the image reading device 18 is transmitted as image data to the image forming apparatus body 3, and an image formed based on the image data is recorded on the sheet P in the image forming apparatus body 3.

The image data used in the image forming apparatus 1 corresponds to a color image formed using a plurality of colors (four colors of black (K), cyan (C), magenta (M), and yellow (Y) in this example). Therefore, a plurality of sets (four sets in this example) of the development device 7, the photoreceptor 8, the cleaning device 9, the charging device 10, and the toner storage device 12 are provided according to the respective colors, and in the example illustrated in FIG. 1, the plurality of sets corresponding to black (K), cyan (C), magenta (M), and yellow (Y) are arranged in this order from right to left in the left-right direction.

In forming an image in the image forming apparatus 1, the sheet P is fed from the feed tray 14 or the manual feed tray 15, and is conveyed to a registration roller 20 by a first conveying roller 19a provided along a sheet conveyance path S. Next, the sheet P is conveyed by the registration roller 20 at a timing matching a toner image on an intermediate transfer belt 21 that is circularly moved in a circumferential direction V in the intermediate transfer belt device 11, and the toner image is transferred onto the sheet P by a transfer roller 22. Thereafter, the sheet P passes through a fixing roller 23 and a pressure roller 24 in the fixing device 13. At this time, the unfixed toner on the sheet P is melted by heat to be fixed. Then, the sheet P on which the toner image is formed is discharged onto the discharge tray 16 via a second conveying roller 19b and a discharge roller 25.

### Optical Scanning Device

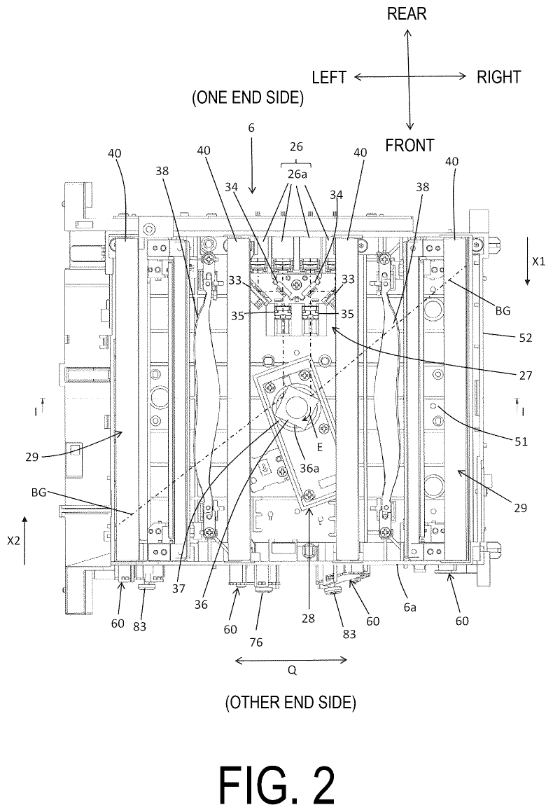

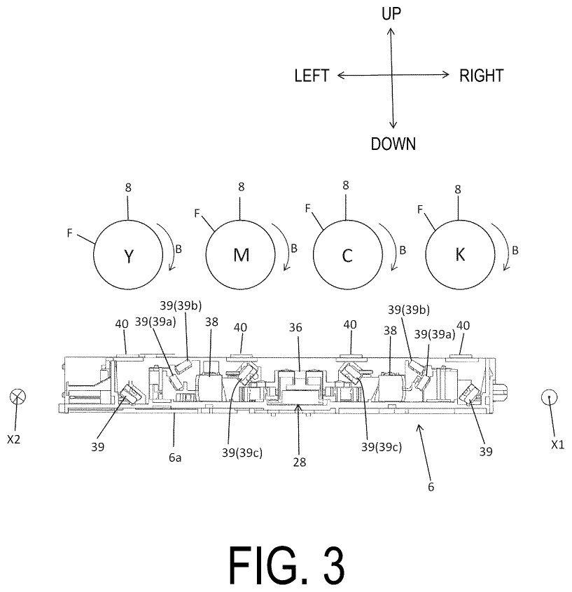

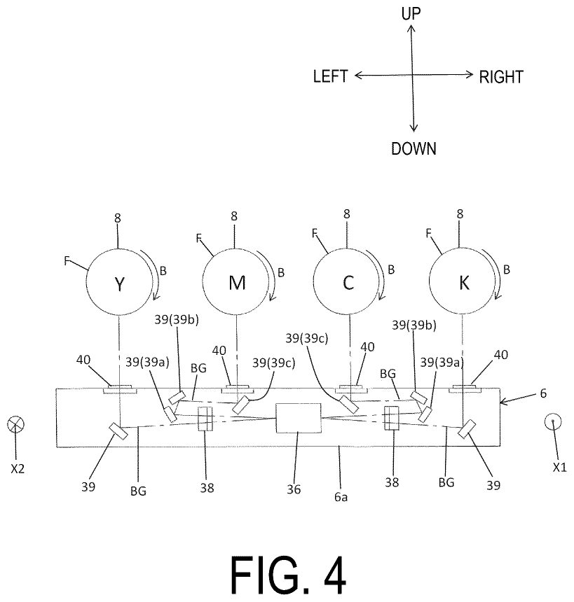

FIG. 2 is a plan view illustrating the optical scanning device 6 of the first embodiment. FIG. 3 is a cross-sectional view taken along line I-I in FIG. 2. FIG. 4 is a schematic side view illustrating a positional relationship between an emission optical system and the photoreceptors of the optical scanning device 6 illustrated in FIG. 3, as viewed from the front side. The optical scanning device 6 includes a housing 6a, and a light source unit 26, an incident optical system 27, a deflector 28, and an emission optical system 29 are provided inside the housing 6a. FIG. 2 illustrates the optical scanning device 6 as viewed from above, and the lower side in FIG. 2 is disposed on the front side (near side) of the image forming apparatus 1 (see FIG. 1), the upper side in FIG. 2 is disposed on the rear side (far side) of the image forming apparatus 1, the right side in FIG. 2 is disposed on the right side of the image forming apparatus 1, and the left side in FIG. 2 is disposed on the left side of the image forming apparatus 1.

As illustrated in FIGS. 2 to 4, the light source unit 26 includes a plurality of light sources 26a (in this example, multi-beam light sources). Each of the light sources 26a emits a beam group BG (specifically, a laser beam group). The incident optical system 27 is disposed between the light source unit 26 and the deflector 28 on an optical path of the beam group BG. The incident optical system 27 causes the beam group BG emitted from the light source unit 26 to be incident on the deflector 28. The deflector 28 deflects and scans the beam group BG incident from the light source unit 26 via the incident optical system 27 in main scanning directions X1 and X2 (see FIG. 2). The emission optical system 29 is disposed on both sides of the deflector 28 in a direction Q orthogonal to the main scanning directions X1 and X2. In the present embodiment, when the optical scanning device 6 is viewed from the front side, the emission optical systems 29 corresponding to black (K) and cyan (C) are disposed on the right side of the deflector 28, and the emission optical systems 29 corresponding to magenta (M) and yellow (Y) are disposed on the left side of the deflector 28. The emission optical systems 29 irradiate scanning target surfaces F of the photoreceptors 8 with the beam group BG from the deflector 28.

In the optical scanning device 6, the beam group BG emitted from the light source unit 26 is made incident on the deflector 28 via the incident optical system 27 to be deflected and scanned in the main scanning directions X1 and X2 by the deflector 28, thereby forming a latent images as image information on the scanning target surfaces F of the surfaces of the photoreceptors 8 via the emission optical systems 29. In the present embodiment, the deflector 28 deflects and scans the beam group BG in the main scanning direction X1 by reflecting the beam group BG toward the emission optical systems 29 on the right side, and deflects and scans the beam group BG in the main scanning direction X2 by reflecting the beam group BG toward the emission optical systems 29 on the left side (see FIG. 2). The beam group BG periodically scans the scanning target surfaces F in the main scanning directions X1 and X2, but since the photoreceptors 8 are rotated in the rotation direction B (see FIGS. 3 and 4), the beam group BG can also scan in a sub-scanning direction (direction Q orthogonal to the main scanning directions X1 and X2) on the photoreceptors 8.

### Light Source Unit

As illustrated in FIG. 2, the light source unit 26 includes the plurality of (in this example, four) light sources 26a corresponding to the respective colors. Each of the light sources 26a includes one or more light emitting elements (in this example, semiconductor laser elements) such as laser diodes, and emits the beam group BG modulated in accordance with image date. Examples of the number of light sources 26a include, but are not limited to, two, four, eight, and sixteen.

### Incident Optical System

The incident optical system 27 (see FIG. 2) irradiates a mirror surface 36a (reflecting surface) of the deflector 28 with the beam group BG emitted from the light source unit 26. The incident optical system 27 includes a plurality of collimator lenses (reference signs omitted) and a plurality of apertures (reference signs omitted) provided in front of the plurality of light sources 26a, a plurality of first reflecting mirrors 33, a plurality of second reflecting mirrors 34, and a plurality of cylindrical lenses 35. In the present embodiment, four light sources 26a corresponding to black (K), cyan (C), magenta (M), and yellow (Y) are arranged in line in the direction Q orthogonal to the main scanning directions X1 and X2, a pair of a collimator lens (reference sign omitted) and an aperture (reference sign omitted) is arranged in front of and near each of the light sources 26a, two first reflecting mirrors 33 are disposed in front of the two light sources 26a corresponding to black (K) and yellow (Y), two second reflecting mirrors 34 are disposed in front of the two light sources 26a corresponding to cyan (C) and magenta (M), two cylindrical lenses 35 are disposed in front of the two second reflecting mirrors 34, and the deflector 28 is disposed in front of the two cylindrical lenses 35.

The collimator lens is an optical component that rectifies the beam group BG emitted from the light source 26a into parallel beams. The aperture is a plate-like member formed with a slit-like opening, and is an optical component that rectifies a beam cross-section into a rectangular shape when the beam group BG passes therethrough. In this example, the incident optical system 27 is configured to cause the beam groups BG from two apertures among the plurality of apertures to pass through the second reflecting mirrors 34 to be incident on the cylindrical lenses 35. The first reflecting mirrors 33 are optical components for reflecting the beam group BG having passed through the remaining apertures and guiding the beam group BG to the cylindrical lenses 35 via the second reflecting mirrors 34. The second reflecting mirror 34 is a mirror that can cause the beam group BG in a specific wavelength region to pass therethrough and reflect the beam group BG in remaining wavelength regions, and for example, a dichroic mirror is used. The cylindrical lens 35 is an optical component for converging the beam group BG reflected from the second reflecting mirror 34 and the beam group BG having passed through the second reflecting mirror 34 toward the mirror surface 36a of the deflector 28.

### Deflector

In this example, the deflector 28 (see FIG. 2) includes a polygon mirror 36 (an example of a rotating polygon mirror and a deflecting mirror) and a drive motor 37 that rotationally drives the polygon mirror 36. The polygon mirror 36 is fixed to a rotary shaft of the drive motor 37, and includes a plurality of mirror surfaces 36a along the rotary shaft at the circumference thereof. The drive motor 37 rotates in a constant rotation direction E at a constant rotation speed. Accordingly, the polygon mirror 36 can deflect and scan the beam group BG incident on the mirror surfaces 36a in the main scanning directions X1 and X2. In the present embodiment, when the optical scanning device 6 is viewed from the front side, the beam group BG from the cylindrical lens 35 on the right side is reflected by the mirror surface 36a of the polygon mirror 36 and guided to the emission optical system 29 on the right side, and the beam group BG from the cylindrical lens 35 on the left side is reflected by the mirror surface 36a of the polygon mirror 36 and guided to the emission optical system 29 on the left side.

### Emission Optical System

As illustrated in FIGS. 2 to 4, the emission optical system 29 reflects and refracts the beam group BG repeatedly scanned in the main scanning directions X1 and X2 to irradiate the scanning target surface F with the beam group BG. The emission optical system 29 includes a first fθ lens 38, a plurality of return mirrors 39, and a plurality of second fθ lenses 40. These optical members of the emission optical system 29 are formed in a rod shape elongated in the main scanning direction X1 and X2 (see FIG. 2), and both ends thereof are attached to the housing 6a. Hereinafter, as for both ends of the optical members of the emission optical system 29 in the longitudinal direction, a start end side (upper side in FIG. 2) of the main scanning direction X1 is referred to as one end, and a terminal end side (lower side in FIG. 2) of the main scanning direction X1 is referred to as the other end.

The first fθ lens 38 is an optical member that corrects the beam group BG, which is reflected from the mirror surface 36a of the deflector 28 and moves at a constant angular speed, so as to move on the scanning target surface F at a constant speed. The return mirror 39 is an optical member that reflects the beam group BG having passed through the first fθ lens 38 and guides the beam group BG to the second fθ lens 40, and converges the beam group BG onto the scanning target surface F.

In the present embodiment, the number of the return mirrors 39 corresponding to black (K) on the rightmost side is one, and the number of the return mirrors 39 corresponding to yellow (Y) on the leftmost side is also one. The one return mirror 39 corresponding to black (K) and the one return mirror 39 corresponding to yellow (Y) are in opposite directions in line symmetry with each other.

In the present embodiment, the number of the return mirrors 39 corresponding to cyan (C) is three, and the number of the return mirrors 39 corresponding to magenta (M) is also three. The three return mirrors 39 corresponding to cyan (C) and the three return mirrors 39 corresponding to magenta (M) are in opposite directions in line symmetry with each other. The three return mirrors 39 corresponding to cyan (C) include a first mirror 39a that reflects the beam group BG from the polygon mirror 36, a second mirror 39b that reflects the beam group BG from the first mirror 39a, and a third mirror 39c that reflects the beam group BG from the second mirror 39b. The beam group BG reflected by the third mirror 39c is guided to the scanning target surface F of the photoreceptor 8 via the second fθ lens 40. The three return mirrors 39 corresponding to magenta (M) include first, second, and third mirrors 39a, 39b, and 39c, similar to the first mirror 39a, the second mirror 39b, and the third mirror 39c corresponding to cyan (C).

As illustrated in FIGS. 2 to 4, the two return mirrors 39 corresponding to black (K) and yellow (Y) and the two return mirrors 39 (third mirrors 39c) corresponding to cyan (C) and magenta (M) are mirrors that guide the beam groups BG to the scanning target surfaces F of the photoreceptors 8 of the respective colors. In an initial stage (before adjustment) of an inspection process of the image forming apparatus 1 (see FIG. 1) assembled in a manufacturing plant, the scanning directions of the beam groups BG from the four return mirrors 39 may not strictly coincide with the ideal main scanning directions X1 and X2 (that is, the axial directions of the photoreceptors 8) and may be slightly deviated (inclined). The optical axis deviation related to the inclination of the optical scanning system of each color is considered to be caused by mounting errors, tolerances, and the like of various optical components assembled in the housing 6a of the optical scanning device 6, and mounting errors, tolerances, and the like of the optical scanning device 6 with respect to the image forming apparatus body 3. Therefore, both ends of the four return mirrors 39 in the longitudinal direction are held by component holders 60 capable of adjusting the position of each of the return mirrors 39 (see FIG. 2). The component holder 60 movably holds one end side (upper side in FIG. 2) and the other end side (lower side in FIG. 2) of the return mirror 39. An adjustment screw 61 capable of moving the other end of the return mirror 39 in the direction Q orthogonal to the main scanning directions X1 and X2 is provided on the other end side (lower side in FIG. 2) of the component holder 60. In moving the other end of the return mirror 39 in the direction Q orthogonal to the main scanning directions X1 and X2 by turning the adjustment screw 61, the one end of the return mirror 39 serves as a supporting point.

Among the plurality of return mirrors 39 corresponding to cyan (C), the first mirror 39a and the second mirror 39b are mirrors for relaying the beam group BG from the polygon mirror 36 to the third mirror 39c, and are fixed in the housing 6a because the position adjustment as for the third mirror 39c is not required. Among the plurality of return mirrors 39 corresponding to magenta (M), the first mirror 39a and the second mirror 39b are mirrors for relaying the beam group BG from the polygon mirror 36 to the third mirror 39c, and are fixed in the housing 6a because the position adjustment as for the third mirror 39c is not required. Hereinafter, a fixing structure on the one end side and the other end side of the first mirror 39a and the second mirror 39b corresponding to cyan (C) will be described. A fixing structure on the one end side and the other end side of the first mirror 39a and the second mirror 39b corresponding to magenta (M) is a structure different from the fixing structure on the one end side and the other end side of the first mirror 39a and the second mirror 39b corresponding to cyan (C) in that the fixing structures are line-symmetrically opposite to each other, and is substantially the same in other respects. Therefore, the description of the fixing structure on the one end side and the other end side of the first mirror 39a and the second mirror 39b corresponding to magenta (M) will be omitted.

As illustrated in FIG. 4, in the present embodiment, since the second fθ lens 40 corresponding to cyan (C) and the third mirror 39c that guides the beam group BG to the second fθ lens 40 are disposed between the polygon mirror 36 and the first fθ lens 38, it is necessary to return the beam group BG that has passed through the first fθ lens 38 from the polygon mirror 36 toward the third mirror 39c. The first mirror 39a and the second mirror 39b are provided for the return of the beam group BG, and the beam group BG passes over the first fθ lens 38 at the time of the return. Specifically, the first mirror 39a is disposed below the second mirror 39b, and the first mirror 39a and the second mirror 39b are fixed in the housing 6a such that the first mirror 39a reflects the beam group BG from the polygon mirror 36 toward the second mirror 39b above, and the second mirror 39b reflects the beam group BG from the first mirror 39a toward the third mirror 39c. Hereinafter, a fixing structure of the first mirror 39a and the second mirror 39b in the housing 6a will be described.

### Fixing Structure of First Mirror and Second Mirror

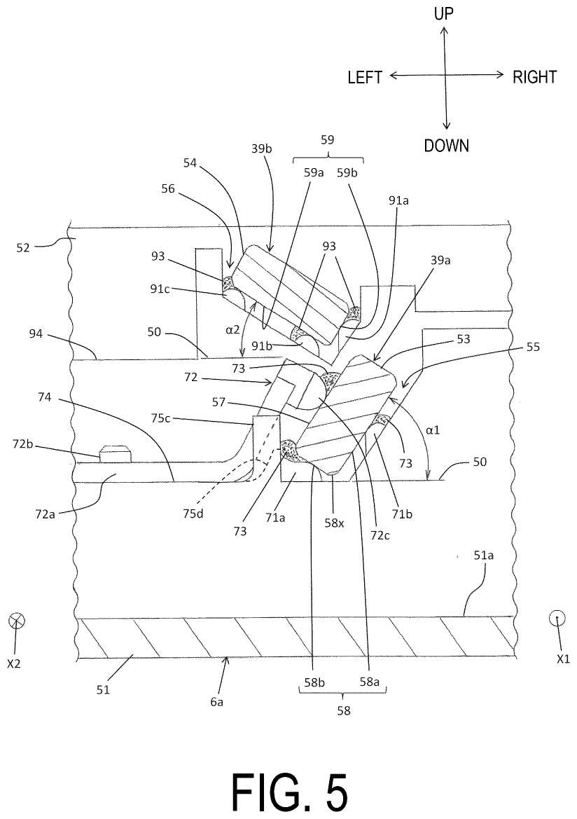

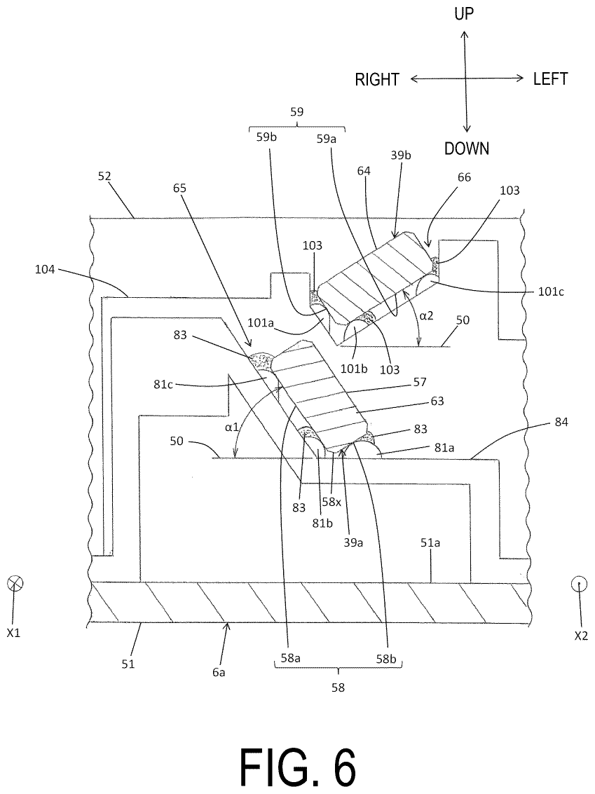

FIG. 5 is a cross-sectional view illustrating a state of the one end side of the optical components fixed to the component fixer in the optical scanning device of the first embodiment, as viewed from the front side. FIG. 6 is a cross-sectional view illustrating a state of the other end side of the optical components fixed to the component fixer in the optical scanning device of the first embodiment, as viewed from the rear side. FIG. 5 illustrates a state of the one end side of the first mirror 39a and the second mirror 39b corresponding to cyan (C), and FIG. 6 illustrates a state of the other end side of the first mirror 39a and the second mirror 39b corresponding to cyan (C).

As illustrated in FIGS. 2 and 5, the housing 6a includes a bottom wall 51 having a substantially rectangular shape and an outer peripheral wall 52 rising along an outer peripheral edge of the bottom wall 51. On the one end side above the bottom wall 51 of the housing 6a, a one-end fixer 55 (hereinafter referred to as a first one-end fixer 55) as a component fixing portion that fixes one end 53 of the first mirror 39a and a one-end fixer 56 (hereinafter referred to as a second one-end fixer 56) as a component fixing portion that fixes one end 54 of the second mirror 39b are provided. In addition, as illustrated in FIGS. 2 and 6, on the other end side above the bottom wall 51 of the housing 6a, an other-end fixer 65 (hereinafter referred to as a first other-end fixer 65) as a component fixing portion that fixes an other end 63 of the first mirror 39a and an other-end fixer 66 (hereinafter referred to as a second other-end fixer 66) as a component fixing portion that fixes an other end 64 of the second mirror 39b are provided.

As illustrated in FIGS. 5 and 6, the first mirror 39a has a shape extending in a longitudinal direction (main scanning direction X1, X2) intersecting the direction of the light emitted from the light source, and in the present embodiment, the first mirror 39a has a rod-like shape with a substantially rectangular cross-sectional shape. The first mirror 39a has an outer peripheral surface facing in a direction orthogonal to the longitudinal direction (main scanning direction X1, X2). The outer peripheral surface of the first mirror 39a includes an incident surface 57 on which the light is incident and a supported surface 58 supported by the first one-end fixer 55. The supported surface 58 includes a back surface 58a parallel to the incident surface 57 and a lower end surface 58b between the incident surface 57 and the back surface 58a. The second mirror 39b has an outer peripheral surface similar to the outer peripheral surface of the first mirror 39a, but a supported surface 59 includes an incident surface 59a and a lower end surface 59b. The first mirror 39a and the second mirror 39b are fixed at both end portions of the incident surfaces 57 and 59a, respectively, on which main scanning light is not incident.

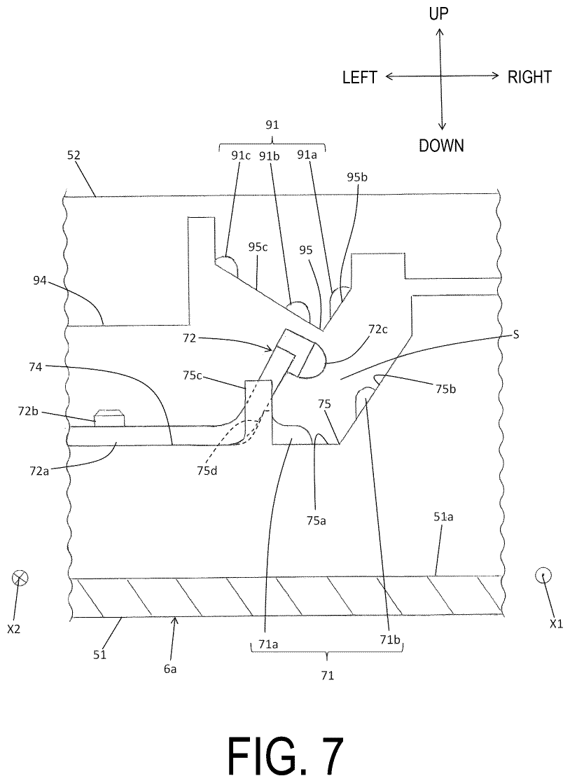

FIG. 7 is a cross-sectional view illustrating a state of the component fixer before component fixing in the optical scanning device of the first embodiment, as viewed from the front side. As illustrated in FIGS. 5 and 7, the first one-end fixer 55 includes a one-end positioner 71 that positions the supported surface 58 at the one end 53 of the first mirror 39a, a plate spring 72 as a biaser that biases the incident surface 57 toward the one-end positioner 71 side, and a one-end adhesive fixer 73 (see FIG. 5) that fixes the one end 53 to the one-end positioner 71. In the present embodiment, the plate spring 72 is fixed to the one end 53 by the one-end adhesive fixer 73, but is not necessarily fixed. Further, in the present embodiment, the plate spring 72 is exemplified as the biaser, but the biaser may be a biasing member capable of biasing the incident surface 57 toward the one-end positioner 71 side, and may be a biasing member other than the plate spring having the shape illustrated in the drawing, and the material may be a metal spring or a resin spring, and the resin spring is preferable from the viewpoint of cost.

More specifically, on the one end side of an upper surface 51a of the bottom wall 51 of the housing 6a (see FIGS. 2 and 7), a first one-end side step portion 74 higher than the upper surface 51a is provided, and a first one-end side recessed portion 75 is provided at an upper surface of the first one-end side step portion 74. The first one-end side recessed portion 75 includes a bottom surface 75a substantially parallel to the upper surface 51a of the bottom wall 51, an inclined surface 75b provided on the right side of the bottom surface 75a and rising toward the right direction, a plate spring guide 75c having a U shape and provided on the left side of the bottom surface 75a, and a plate spring stopper 75d having a projecting shape and provided on a lower portion of the plate spring guide 75c.

As illustrated in FIGS. 5 and 7, the one-end positioner 71 includes a one-end side first protruding portion 71a that supports the lower end surface 58b at the one end 53 of the first mirror 39a, and a one-end side second protruding portion 71b that supports the back surface 58a at the one end 53 of the first mirror 39a. The one-end side first protruding portion 71a is provided at a corner portion between the bottom surface 75a and the plate spring guide 75c, and the one-end side second protruding portion 71b is provided at the inclined surface 75b. The one-end side first protruding portion 71a and the one-end side second protruding portion 71b each have a rounded shape, and these protruding portions are in point contact with the lower end surface 58b and/or the back surface 58a of the one end 53 of the first mirror 39a, respectively.

The plate spring 72 includes a plate spring body 72a having an elongated shape, a screw 72b that fixes a base end of the plate spring body 72a to the first one-end side step portion 74, and a contact portion 72c having a hemispherical shape and provided at a leading end of the plate spring body 72a. In the present embodiment, the plate spring body 72a and the contact portion 72c are integrally molded with resin, but may be press-molded with a metal piece, for example. In the plate spring body 72a, the base end is fixed to the left side of the plate spring guide 75c of the first one-end side step portion 74, a portion from an intermediate portion in the longitudinal direction to the leading end is curved upward and rises in an oblique direction, the leading end side passes through a U-shaped space of the plate spring guide 75c, and the contact portion 72c at the leading end faces the one-end side second protruding portion 71b. In a state where the first mirror 39a is not fixed to the first one-end fixer 55, the intermediate portion of the plate spring body 72a is in contact with the plate spring stopper 75d so as to restrict the movement of the contact portion 72c toward the one-end side second protruding portion 71b side, whereby a gap S (see FIG. 7) is formed between the contact portion 72c and the one-end side second protruding portion 71b. The size of the gap S, which is the minimum length from the contact portion 72c to the one-end side second protruding portion 71b, is set to be smaller than a thickness T of the first mirror 39a (see FIG. 5). For example, when the thickness T of the first mirror 39a is 10 mm, the size of the gap S is about 8 mm to 9 mm.

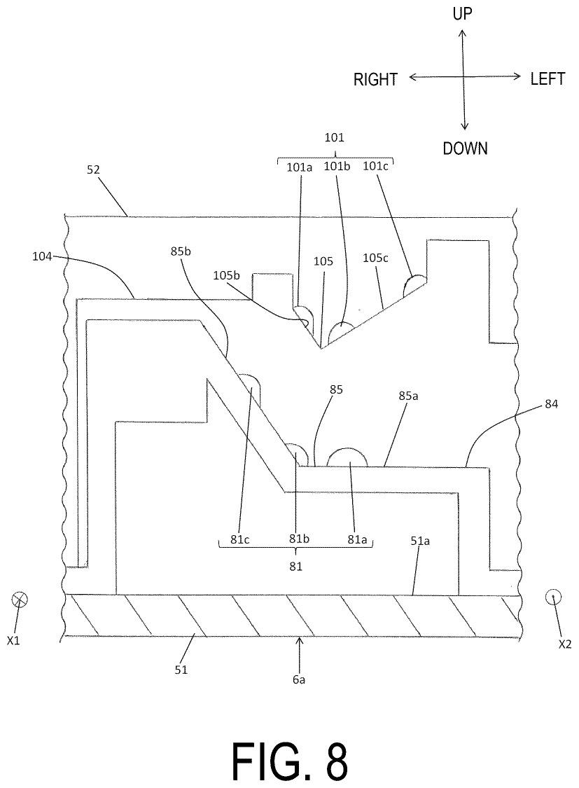

FIG. 8 is a cross-sectional view illustrating a state of the component fixer before component fixing in the optical scanning device of the first embodiment, as viewed from the rear side. As illustrated in FIGS. 6 and 8, the first other-end fixer 65 includes an other-end positioner 81 that positions the supported surface 58 at the other end 63 of the first mirror 39a, and an other-end adhesive fixer 83 (see FIG. 6) that fixes the other end 63 to the other-end positioner 81.

More specifically, on the other end side of the upper surface 51a of the bottom wall 51 of the housing 6a (see FIGS. 2 and 8), a first other-end side step portion 84 higher than the upper surface 51a is provided, and a first other-end side recessed portion 85 is provided at an upper surface of the first other-end side step portion 84. The first other-end side recessed portion 85 includes a bottom surface 85a substantially parallel to the upper surface 51a of the bottom wall 51, and an inclined surface 85b provided on the right side of the bottom surface 85a and rising toward the right direction. Note that the first other-end side recessed portion 85 does not include the plate spring 72 (see FIG. 7) which is provided at the first one-end side recessed portion 75.

As illustrated in FIGS. 6 and 8, the other-end positioner 81 includes an other-end side first protruding portion 81a that supports the lower end surface 58b at the other end 63 of the first mirror 39a, and an other-end side second protruding portion 81b and an other-end side third protruding portion 81c that support the back surface 58a at the other end 63 of the first mirror 39a. The other-end side first protruding portion 81a is provided in the vicinity of the inclined surface 85b at the bottom surface 85a, the other-end side second protruding portion 81b is provided at a lower portion of the inclined surface 85b, and the other-end side third protruding portion 81c is provided at an upper portion of the inclined surface 85b. The other-end side first protruding portion 81a, the other-end side second protruding portion 81b, and the other-end side third protruding portion 81c each have a rounded shape, and these protruding portions are in point contact with the lower end surface 58b and/or the back surface 58a of the other end 63 of the first mirror 39a, respectively.

Returning to FIGS. 5 and 7, the second one-end fixer 56 includes a one-end positioner 91 that positions the supported surface 59 at the one end 54 of the second mirror 39b, and a one-end adhesive fixer 93 (see FIG. 5) that fixes the one end 53 to the one-end positioner 91.

More specifically, a second one-end side step portion 94, which is higher than the first one-end side step portion 74, is provided between the outer peripheral wall 52 and the first one-end side step portion 74 on the one end side of the upper surface 51a of the bottom wall 51 of the housing 6a (see FIGS. 2 and 7), and a second one-end side recessed portion 95 is provided at an upper surface of the second one-end side step portion 94. The second one-end side recessed portion 95 includes an inclined surface 95b that rises toward the right direction and an inclined surface 95c that rises toward the left direction.

As illustrated in FIGS. 5 and 7, the one-end positioner 91 that supports the one end 54 of the second mirror 39b includes a one-end side first protruding portion 91a that supports the lower end surface 59b at the one end 54 of the second mirror 39b, and a one-end side second protruding portion 91b and a one-end side third protruding portion 91c that support the incident surface 59a at the one end 54 of the second mirror 39b. The one-end side first protruding portion 91a is provided at the inclined surface 95b, the one-end side second protruding portion 91b is provided at a lower portion of the inclined surface 95c, and the one-end side third protruding portion 91c is provided at an upper portion of the inclined surface 95c. The one-end side first protruding portion 91a, the one-end side second protruding portion 91b, and the one-end side third protruding portion 91c each have a rounded shape, and these protruding portions are in point contact with the lower end surface 59b and/or the incident surface 59a of the one end 54 of the second mirror 39b, respectively.

Returning to FIGS. 6 and 8, the second other-end fixer 66 includes an other-end positioner 101 that positions the supported surface 59 at the other end 64 of the second mirror 39b, and an other-end adhesive fixer 103 (see FIG. 6) that fixes the other end 64 to the other-end positioner 101.

More specifically, a second other-end side step portion 104, which is higher than the first other-end side step portion 84, is provided between the outer peripheral wall 52 and the first other-end side step portion 84 on the other end side of the upper surface 51a of the bottom wall 51 of the housing 6a (see FIGS. 2 and 8), and a second other-end side recessed portion 105 is provided at an upper surface of the second other-end side step portion 104. The second other-end side recessed portion 105 includes an inclined surface 105b that rises toward the right direction and an inclined surface 105c that rises toward the left direction.

As illustrated in FIGS. 6 and 8, the other-end positioner 101 includes an other-end side first protruding portion 101a that supports the lower end surface 59b at the other end 64 of the second mirror 39b, and an other-end side second protruding portion 101b and an other-end side third protruding portion 101c that support the incident surface 59a at the other end 64 of the second mirror 39b. The other-end side first protruding portion 101a is provided at the inclined surface 105b, the other-end side second protruding portion 101b is provided at a lower portion of the inclined surface 105c, and the other-end side third protruding portion 101c is provided at an upper portion of the inclined surface 105c. The other-end side first protruding portion 101a, the other-end side second protruding portion 101b, and the other-end side third protruding portion 101c each have a rounded shape, and these protruding portions are in point contact with the lower end surface 59b and/or the incident surface 59a of the other end 64 of the second mirror 39b, respectively.

As illustrated in FIGS. 5 and 6, in a state where the first mirror 39a is fixed to the first one-end fixer 55 and the first other-end fixer 65, the one-end side first protruding portion 71a and the one-end side second protruding portion 71b of the first one-end fixer 55 and the other-end side first protruding portion 81a, the other-end side second protruding portion 81b, and the other-end side third protruding portion 81c of the first other-end fixer 65 support the first mirror 39a such that an inclination angle α1 of the back surface 58a of the first mirror 39a is 45° or more and less than 90° with respect to a horizontal plane 50. The inclination angle α1 is an angle at which the light incident onto the first mirror 39a is guided to the incident surface 59a of the second mirror 39b, and in the present embodiment, the inclination angle α1 is about 60°. In particular, the other-end side second protruding portion 81b and the other-end side third protruding portion 81c of the first other-end fixer 65 are important portions for determining the inclination angle α1 of the first mirror 39a. In addition, the one-end side first protruding portion 71a and the other-end side first protruding portion 81a are important portions for determining the height position of the first mirror 39a with respect to the upper surface 51a of the bottom wall 51 of the housing 6a.

In contrast, in a state where the second mirror 39b is fixed to the second one-end fixer 56 and the second other-end fixer 66, the one-end side first protruding portion 91a, the one-end side second protruding portion 91b, and the one-end side third protruding portion 91c of the second one-end fixer 56 and the other-end side first protruding portion 101a, the other-end side second protruding portion 101b, and the other-end side third protruding portion 101c of the second other-end fixer 66 support the second mirror 39b such that an inclination angle α2 of the incident surface 59a of the second mirror 39b is less than 45° with respect to the horizontal plane 50. The inclination angle α2 is an angle at which the light incident onto the second mirror 39b is guided to the incident surface of the third mirror 39c (see FIG. 4), and in the present embodiment, the inclination angle α2 is about 30°.

### First Mirror Fixing Operation

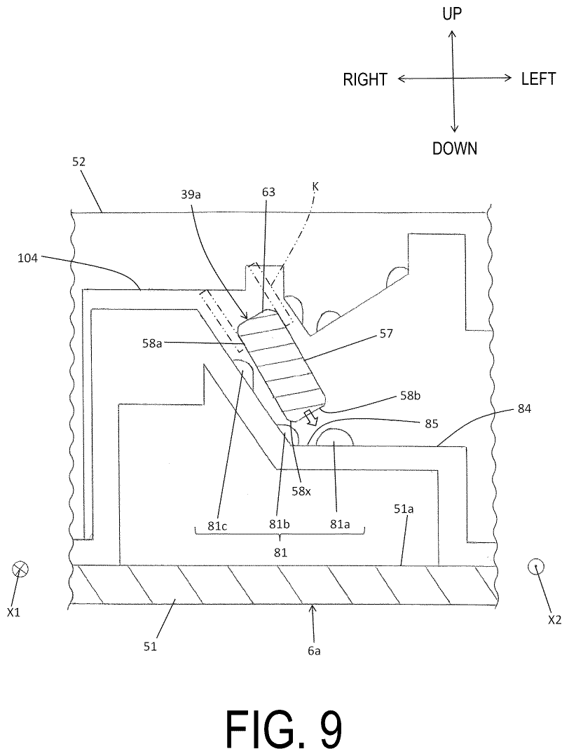

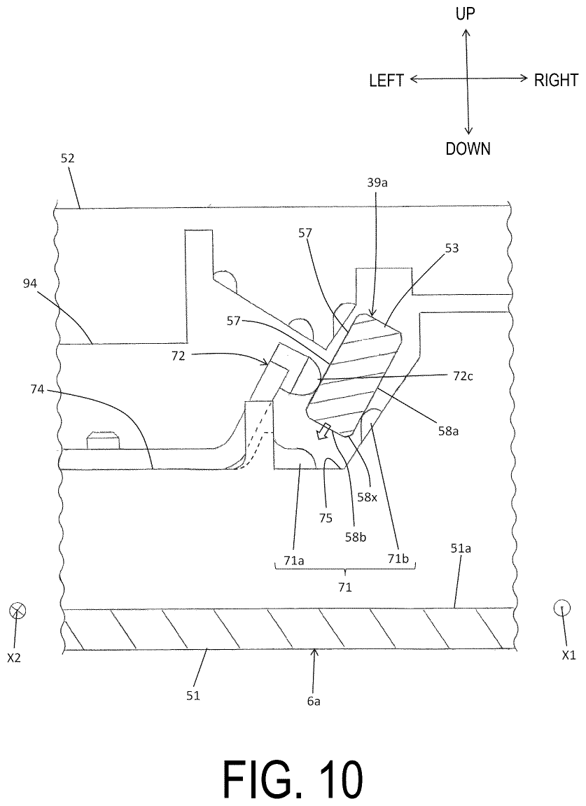

FIG. 9 is a cross-sectional view illustrating a state of fixing the other end of the optical component to the component fixer in the optical scanning device of the first embodiment, as viewed from the rear side. FIG. 10 is a cross-sectional view illustrating a state of fixing the one end of the optical component to the component fixer in the optical scanning device of the first embodiment, as viewed from the front side. An operation of fixing the first mirror 39a to the first one-end fixer 55 and the first other-end fixer 65 is performed as follows. As illustrated in FIG. 9, first, the first mirror 39a is held by a tool K indicated by dash-double-dot lines in the vicinity of the other end 63, and the other end 63 is brought close to the other-end side first protruding portion 81a, the other-end side second protruding portion 81b, and the other-end side third protruding portion 81c of the first other-end side recessed portion 85. At this time, the operation is performed in a state where the lower end surface 58b of the first mirror 39a is directed downward and the back surface 58a is directed toward the other-end side third protruding portion 81c side. In contrast, as illustrated in FIG. 10, on the side of the one end 53 of the first mirror 39a, the one end 53 is pushed into the gap S between the one-end side second protruding portion 71b of the first one-end side recessed portion 75 and the contact portion 72c of the plate spring 72.

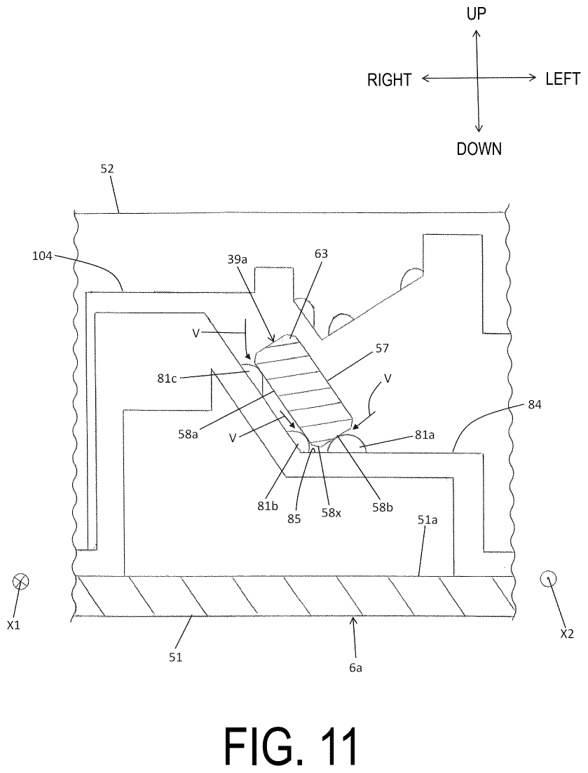

FIG. 11 is a cross-sectional view illustrating a state where the other end of the optical component is temporarily fixed to the component fixer in the optical scanning device of the first embodiment, as viewed from the rear side. As illustrated in FIG. 11, the other end 63 of the first mirror 39a is brought into contact with the other-end side first protruding portion 81a, the other-end side second protruding portion 81b, and the other-end side third protruding portion 81c of the first other-end side recessed portion 85, so that the first mirror 39a is positioned to the other-end positioner 81 (see FIG. 8). At this time, the other end 63 of the first mirror 39a is positioned in an inclined state at the inclination angle α1 such that the lower end surface 58b is in contact with the other-end side first protruding portion 81a, the back surface 58a is in contact with the other-end side second protruding portion 81b and the other-end side third protruding portion 81c, and a corner portion 58x between the back surface 58a and the lower end surface 58b enters a space between the other-end side first protruding portion 81a and the other-end side second protruding portion 81b.

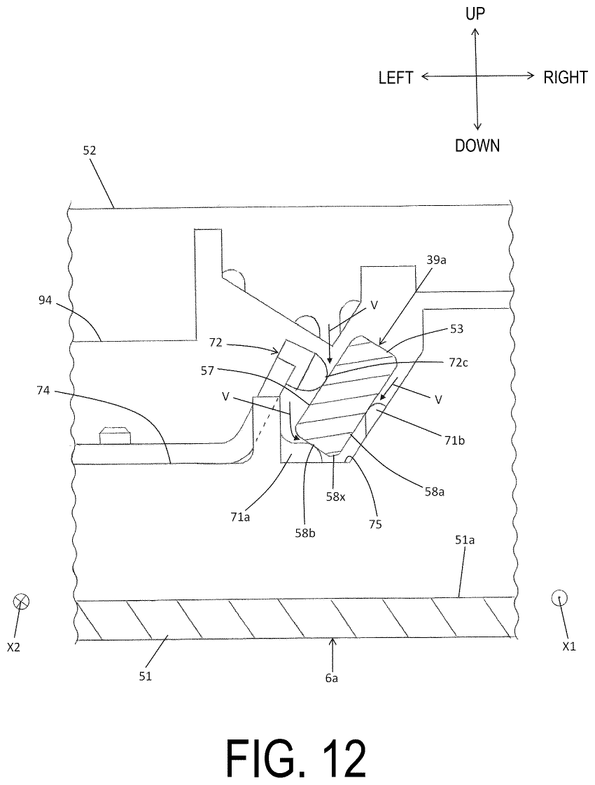

FIG. 12 is a cross-sectional view illustrating a state where the one end of the optical component is temporarily fixed to the component fixer in the optical scanning device of the first embodiment, as viewed from the front side. As illustrated in FIGS. 11 and 12, when the other end 63 of the first mirror 39a is positioned to the other-end positioner 81, the one end 53 of the first mirror 39a is further pushed in while being in slide contact with the one-end side second protruding portion 71b and the contact portion 72c of the plate spring 72. Then, the one end 53 of the first mirror 39a is positioned in an inclined state at the inclination angle α1 such that the lower end surface 58b is in contact with the one-end side first protruding portion 71a, the back surface 58a is in contact with the one-end side second protruding portion 71b, the corner portion 58x between the back surface 58a and the lower end surface 58b enters a space between the one-end side first protruding portion 71a and the one-end side second protruding portion 71b, and the incident surface 57 is biased by the plate spring 72 toward the one-end side second protruding portion 71b side. Note that the positioning operation up to this point may be performed such that the one end 53 of the first mirror 39a is first positioned to the one-end side first protruding portion 71a and the one-end side second protruding portion 71b, and then the other end 63 of the first mirror 39a is positioned to the other-end side first protruding portion 81a, the other-end side second protruding portion 81b, and the other-end side third protruding portion 81c.

The first mirror 39a positioned in this manner is temporarily fixed to the positioning location by the contact portion 72c of the plate spring 72 biasing the incident surface 57 of the first mirror 39a toward the one-end side second protruding portion 71b, until the next adhesive application process and hardening process are completed.

Thereafter, as illustrated in FIG. 11, an adhesive V is applied to contact portions between the other end 63 of the first mirror 39a and each of the protruding portions for positioning (the other-end side first protruding portion 81a, the other-end side second protruding portion 81b, and the other-end side third protruding portion 81c) and cured to form the other-end adhesive fixer 83 (see FIG. 6). As the adhesive V, for example, an ultraviolet curable adhesive can be used. While the adhesive V is applied and cured, the first mirror 39a is pressed against the positioning location by the plate spring 72. Therefore, even when the inclination angle α1 of the first mirror 39a is as large as 45° or more and less than 90°, it is possible to prevent the first mirror 39a from falling down and falling off from the positioning location without using the tool K for maintaining the first mirror 39a at the positioning location, and to easily and stably perform the application and hardening processes of the adhesive V. During the application and hardening processes of the adhesive V, the tool K may be used to further stabilize the other end 63 side of the first mirror 39a.

By fixing the other end 63 of the first mirror 39a to the positioning location by the other-end adhesive fixer 83, the operation of fixing the first mirror 39a to the housing 6a can be completed while the one end 53 side of the first mirror 39a is left as it is. In the present embodiment, in order to fix the first mirror 39a to the housing 6a more firmly, the one-end adhesive fixer 73 (see FIG. 5) is also formed on the one end 53 side. At this time, as illustrated in FIG. 12, the adhesive V is applied to contact portions between the one end 53 of the first mirror 39a and each of the protruding portions for positioning (the one-end side first protruding portion 71a, the one-end side second protruding portion 71b, and the contact portion 72c) and cured to form the one-end adhesive fixer 73. Note that the one-end adhesive fixer 73 may be omitted.

Incidentally, as illustrated in FIGS. 9 and 11, since the positioning of the other end 63 of the first mirror 39a is performed only by placing the other end 63 on the other-end positioner 81, there is little possibility that the components are scraped, for example, due to the other end 63 of the first mirror 39a being rubbed against the protruding portions for positioning (the other-end side first protruding portion 81a, the other-end side second protruding portion 81b, or the other-end side third protruding portion 81c). On the other hand, as illustrated in FIGS. 10 and 12, when the one end 53 of the first mirror 39a is pushed into the gap S between the one-end side second protruding portion 71b of the first one-end side recessed portion 75 and the contact portion 72c of the plate spring 72, corner portions of the first mirror 39a are rubbed against the contact portion 72c and/or the one-end side second protruding portion 71b. Therefore, there is a possibility that a part of the contact portion 72c and/or a part of the one-end side second protruding portion 71b are scraped off, respectively, causing an influence on the device performance, but the influence is suppressed as follows in the present embodiment.

First, in the case of a known optical scanning device, since a plate spring is provided on both end sides of a mirror, there is a possibility that a component is scraped on both end sides of the mirror. But, in the present embodiment, since the plate spring 72 is provided only on the one end 53 side of the first mirror 39a, the first mirror 39a is easily inserted, and the possibility of the components being scraped is restricted to only on the one end side of the first mirror 39a. Therefore, the possibility that an inclination angle failure of the mirror occurs due to the scraping of the component, and the inclination angle failure leads to an optical axis failure, an optical axis arrival failure, and a beam diameter failure, resulting in a performance failure, is suppressed in the present embodiment as compared with Patent Document 1.

Second, in the present embodiment, even when a part of the contact portion 72c and/or a part of the one-end side second protruding portion 71b are/is scraped in positioning the one end 53 of the first mirror 39a, the inclination angle α1 of the back surface 58a of the first mirror 39a can be determined by fixing the other end 63 of the first mirror 39a in a state of being in contact with two points of the other-end side second protruding portion 81b and the other-end side third protruding portion 81c with the other-end adhesive fixer 83. Therefore, the influence of the scraping of the components on the device performance is suppressed.

Further, the fixing structure of the first mirror 39a in the present embodiment is configured such that the state where the first mirror 39a is positioned at the positioning location is maintained (temporarily fixed) by the plate spring 72 while the adhesive V is applied and cured, and thus is a simple structure without using a complicated mechanism and with a small number of components, facilitating the fixing operation of the first mirror 39a. The inclination angle α1 of the first mirror 39a is 45° or more and less than 90° which is larger than the inclination angle α2 of the second mirror 39b. Therefore, the operation of fixing the first mirror 39a to the first one-end fixer 55 and the first other-end fixer 65 is more difficult than the operation of fixing the second mirror 39b to the second one-end fixer 56 and the second other-end fixer 66 because the first mirror 39a is more likely to fall down, but the plate spring 72 provided at the first one-end fixer 55 contributes to the ease of the operation.

### Second Mirror Fixing Operation

After the first mirror 39a is fixed to the positioning location, the second mirror 39b is fixed to a positioning location in the same manner as the operation of fixing the first mirror 39a to the positioning location (see FIGS. 5 and 6). At this time, the inclination angle α2 of the second mirror 39b when positioned to the positioning location is smaller than the inclination angle α1 of the first mirror 39a. Therefore, even without a temporary fixing member such as the plate spring 72 for temporarily fixing the first mirror 39a to the positioning location, the state where the second mirror 39b is positioned to the positioning location can be stably maintained, and an adhesive (not illustrated) can be easily applied to the contact portions between the second mirror 39b and the positioning location and cured. Note that a temporary fixing member including a biasing member such as a plate spring may be provided also for the second mirror 39b.

### Second Embodiment

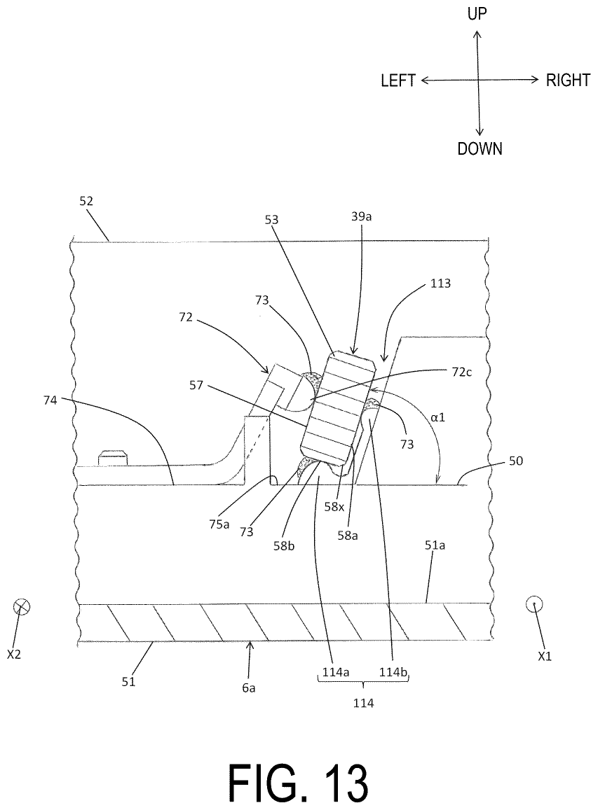

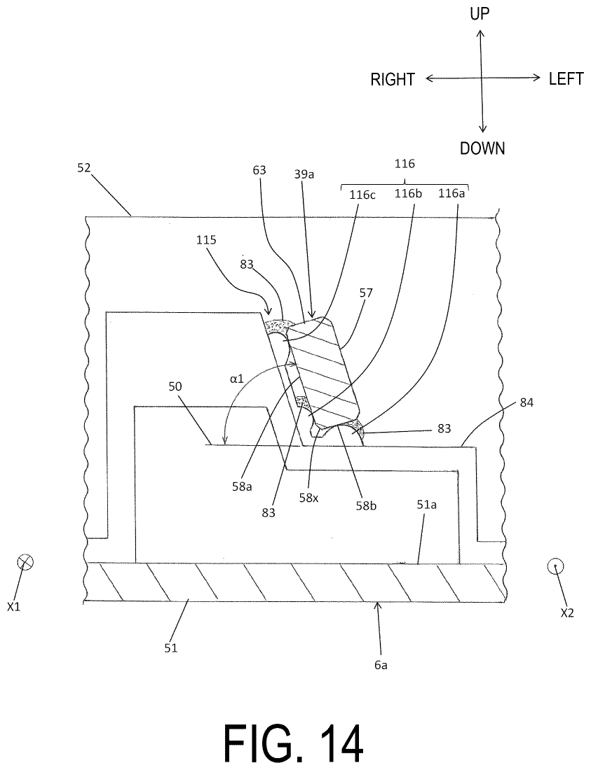

FIG. 13 is a cross-sectional view illustrating a state of one end side of an optical component fixed to a component fixer in an optical scanning device of a second embodiment, as viewed from the front side. FIG. 14 is a cross-sectional view illustrating a state of an other end side of the optical component fixed to the component fixer in the optical scanning device of the second embodiment, as viewed from the rear side. In FIGS. 13 and 14, the same reference signs are assigned to the same elements as those in FIGS. 5 and 6. The fixing structure of the first mirror 39a of the second embodiment is substantially the same as the fixing structure of the first mirror 39a of the first embodiment, but is different in the following points.

In the second embodiment, at a one-end fixer 113 that fixes the one end 53 of the first mirror 39a, a one-end positioner 114 includes a one-end side first protruding portion 114a and a one-end side second protruding portion 114b that are integrated with each other (see FIG. 13). Further, at an other-end fixer 115 that fixes the other end 63 of the first mirror 39a, an other-end positioner 116 includes an other-end side first protruding portion 116a, an other-end side second protruding portion 116b, and an other-end side third protruding portion 116c that are integrated with one another. Furthermore, the inclination angle α1 of each of the first mirrors 39a positioned by the one-end positioner 114 and the other-end positioner 116 is larger than that in the first embodiment. In this example, the inclination angle α1 is about 70°.

### Third Embodiment

In the first embodiment illustrated in FIG. 5 and the second embodiment illustrated in FIG. 13, the case where the back surface 58a and the lower end surface 58b of the first mirror 39a are positioned and the incident surface 57 of the first mirror 39a is pressed by the plate spring 72 has been exemplified. But, in another optical scanning device (not illustrated), the incident surface 57 and the lower end surface 58b of the first mirror 39a may be positioned and the back surface 58a of the first mirror 39a may be pressed by the plate spring 72.

### Fourth Embodiment

In the fixing structure of the first mirror 39a in the first to third embodiments, as illustrated in FIGS. 5 and 6, the case where the first one-end fixer 55 is provided with one protruding portion for positioning (the one-end side second protruding portion 71b) and the first other-end fixer 65 is provided with two protruding portions for positioning (the other-end side second protruding portion 81b and the other-end side third protruding portion 81c) in order to support the back surface 58a of the first mirror 39a at the inclination angle α1 has been exemplified. But, the fixing structure is not limited thereto. The number of protruding portions for positioning that support the back surface 58a of the first mirror 39a may be, for example, at least one or two or more at the first one-end fixer 55, and may be at least two or three or more at the first other-end fixer 65, and even in these cases, the back surface 58a of the first mirror 39a is supported at the inclination angle α1.

### Fifth Embodiment

The fixing structure of the first mirror 39a in the first to fourth embodiments may be used as the fixing structure of the second mirror 39b.

### Other Embodiments

In the fixing structure of the first mirror 39a in the first to fifth embodiments, the case where the plate spring 72 is disposed on the one end side (see FIG. 2) of the optical scanning device 6 has been exemplified, but the plate spring 72 may be disposed on the other end side of the optical scanning device 6.

What is claimed is:

1. An optical scanning device comprising:
a light source;
an optical component irradiated with light from the light source;
a housing that accommodates the optical component; and
a component fixer that fixes the optical component in the housing,
the optical component having a shape extending in a longitudinal direction intersecting an irradiation direction of the light, and having an outer peripheral surface facing a direction orthogonal to the longitudinal direction,
the outer peripheral surface of the optical component including one surface and another surface which is supported by the component fixer,
the component fixer including a one-end fixer that fixes one end of the optical component in the longitudinal direction and an other-end fixer that fixes an other end of the optical component in the longitudinal direction,
the one-end fixer including a one-end positioner that positions the other surface of the one end of the optical component and a biaser that biases the one surface to the one-end positioner side,
the other-end fixer including an other-end positioner that positions the other surface of the other end of the optical component and an other-end adhesive fixer by which the other end is fixed to the other-end positioner,
the one-end positioner including at least one one-end side protruding portion that supports the other surface in an inclined state with respect to a horizontal plane,
the other-end positioner including at least two other-end side protruding portions that support the other surface in an inclined state with respect to the horizontal plane, and
the other-end adhesive fixer including portions at which the other surface is fixed to the at least two other-end side protruding portions.

2. The optical scanning device according to claim 1, wherein
the one surface is an incident surface on which the light is incident, and
the biaser biases the incident surface to the one-end positioner side.

3. The optical scanning device according to claim 1, wherein
the other surface is a flat surface, and
an inclination angle of the other surface of the optical component fixed to the component fixer in an inclined state with respect to the horizontal plane is 45° or more and less than 90°.

4. The optical scanning device according to claim 1, wherein
the one-end fixer further includes a one-end adhesive fixer by which the one end is fixed to the one-end positioner, and
the one-end adhesive fixer includes a portion at which the other surface is fixed to the at least one one-end side protruding portion.

5. The optical scanning device according to claim 4, wherein the one-end adhesive fixer includes a portion at which the other surface is fixed to the biaser.

6. The optical scanning device according to claim 1, wherein
the biaser includes a contact portion that is in contact with a part of the one surface, and
the contact portion is formed in a hemispherical shape.

7. The optical scanning device according to claim 1, wherein
the outer peripheral surface of the optical component includes a lower end surface between the one surface and the other surface,
the one-end positioner further includes a one-end side protruding portion that is in contact with the lower end surface and supports the lower end surface, and
the other-end positioner further includes an other-end side protruding portion that is in contact with the lower end surface and supports the lower end surface.

8. The optical scanning device according to claim 7, wherein the one-end side protruding portion and the other-end side protruding portion support the optical component such that an inclination angle of the other surface of the optical component fixed to the component fixer in an inclined state with respect to the horizontal plane is 45° or more and less than 90°.

9. The optical scanning device according to claim 1, wherein the optical component is a mirror.

10. An image forming apparatus comprising:
the optical scanning device according to claim 1;
a photoreceptor on which a latent image is formed by being irradiated with the light from the optical scanning device; and
a development device that develops the latent image formed on the photoreceptor.

11. A method of manufacturing the optical scanning device according to claim 1, the method comprising:
a step of bringing the other surface of the other end of the optical component into contact with the at least two other-end side protruding portions of the other-end positioner, positioning the other end of the optical component to the other-end positioner in an inclined state with respect to the horizontal plane, bringing the other surface of the one end of the optical component into contact with the at least one one-end side protruding portion of the one-end positioner positioning the one end of the optical component to the one-end positioner in an inclined state with respect to the horizontal plane, and biasing the one surface toward the one-end positioner side by the biaser; and
a step of applying an adhesive to contact portions between the at least two other-end side protruding portions and the other surface of the optical component and curing the adhesive to form the other-end adhesive fixer.
